(19) United States
(12) Patent Application Publication
(10) Pub. No.: US 2009/0322690 A1
(43) Pub. Date: Dec. 31, 2009

(54) Screen display

(75) Inventors: Kirsi-Maria Hiltunen, Ruukki (FI); Mika Petteri Mustonen, Ii (FI); Kari Matias Severinkangas, Oulu (FI)

Correspondence Address: HARRINGTON & SMITH, PC, 4 RESEARCH DRIVE, Suite 202, SHELTON, CT, 06484-6212, US

(73) Assignee: Nokia Corporation

(21) Appl. No.: 12/215,833

(22) Filed: Jun. 30, 2008

(51) Int. Cl. G09G 5/00

(52) U.S. Cl. 345/173; 345/1.3

(57) ABSTRACT

An apparatus including a housing; at least one display screen on a first side of the housing; and a controller. The controller is configured to display a first display on the at least one display screen and a second display on the at least one display screen at a same time such that the first display has a bottom side proximate a bottom end of the at least one display screen and the second display has a bottom side proximate a top end of the at least one display screen. The first display and the second display are generally flipped relative to each other.

### BACKGROUND OF THE INVENTION

1. Field of the Invention

The invention relates to presentation of displays on a display screen(s) and, more particularly, viewing of the displays by multiple people.

2. Brief Description of Prior Developments

Currently mobile telephone displays do not support shared usage of the telephone by more than one user at a same time. The devices are so small that it is quite difficult for two people to view a display on the relatively small display screen at the same time even when the two people are sitting right next to each other.

Mobile telephone handsets are know which have two display screens. However, the usage of the display screens is traditional in a sense that the second display screen is meant for a user to view things and the first display screen (a touch screen) is meant for the same user to control things. The two display screens do not support shared experiences, i.e. they have the same problems as traditional phones with one display (touch or non-touch).

Currently, if a first person wants to share something on the display(s) of his/her phone, the first person has to give the second person the phone or at least point the display screen to the second person thereby preventing the first person from viewing the display screen at a same time. Sharing images, such as photographs, might be especially problematic. For example if the telephone of the first person has a lot of images, some of which the first person does not want the second person to see, but the first person still wants the second person to view multiple ones of the images, the first person has to open one image, give the phone to the second person, the second person looks at the image and then gives the phone back to the first person. The first person then has to open another image, give the phone to the second person again, and so on and so on. This is very cumbersome for the two people.

Another problem is that mobile phones do not support shared gaming experiences together on a single handset.

### SUMMARY

The following summary is merely intended to be exemplary. The summary is not intended to limit the scope of the claimed invention.

In accordance with one aspect of the invention, an apparatus is provided including a housing; at least one display screen on a first side of the housing; and a controller. The controller is configured to display a first display on the at least one display screen and a second display on the at least one display screen at a same time such that the first display has a bottom side proximate a bottom end of the at least one display screen and the second display has a bottom side proximate a top end of the at least one display screen. The first display and the second display are generally flipped relative to each other.

In accordance with another aspect of the invention, a method is provided comprising displaying a first display on at least one display screen of an apparatus, wherein the first display has a bottom side proximate a bottom end of the at least one display screen; and displaying a second display on the at least one display screen at a same time that the first display is displayed on the at least one display screen, wherein the second display has a bottom side proximate a top end of the at least one display screen, wherein the second display is flipped about 180 degrees relative to the first display.

In accordance with another aspect of the invention, a program storage device is provided which is readable by an apparatus, tangibly embodying a program of instructions executable by the apparatus for performing operations to present displays on at least one display screen of the apparatus, the operations comprising displaying a first one of the displays on the at least one display screen, wherein the first display has a bottom side proximate a bottom end of the at least one display screen; and displaying a second one of the displays on the at least one display screen at a same time that the first display is displayed on the at least one display screen, wherein the second display has a bottom side proximate a top end of the at least one display screen, wherein the second display is flipped about 180 degrees relative to the first display.

In accordance with another aspect of the invention, an apparatus is provided comprising a housing; at least one display screen on a first side of the housing; and a controller. The controller is configured to display a first display on the at least one display screen and a second display on the at least one display screen at a same time. The controller is configured to operate in a first mode of operation to display the first display with a bottom side proximate a bottom end of the at least one display screen and the second display with a bottom side proximate a middle of the housing. The controller is configured to operate in a second mode of operation to display the first display with its bottom side proximate the bottom end of the at least one display screen and the second display with its bottom side proximate a top end of the at least one display screen such that the first display and the second display are generally flipped relative to each other in the second mode of operation.

In accordance with another aspect of the invention, a method is provided comprising displaying a first display on at least one display screen of an apparatus, wherein the first display has a bottom side proximate a bottom end of the at least one display screen; displaying a second display on the at least one display screen of the apparatus at a same time that the first display is displayed on the at least one display screen, wherein the second display is displayed in a first orientation having a bottom side opposite a top side of first display; and switching orientation of the second display on the at least one display screen to a second orientation having the bottom side of the second display being located at a top end of the at least one display screen, wherein orientation of the first display remains unchanged when the orientation of the second display is switched from the first orientation to the second orientation.

In accordance with another aspect of the invention, a program storage device is provided which is readable by an apparatus, tangibly embodying a program of instructions executable by the apparatus for performing operations to present displays on at least one display screen of the apparatus, the operations comprising displaying a first one of the displays on at least one display screen, wherein the first display has a bottom side proximate a bottom end of the at least one display screen; displaying a second one of the displays on the at least one display screen at a same time that the first display is displayed on the at least one display screen, wherein the second display is displayed in a first orientation having a bottom side opposite a top side of first display; and switching orientation of the second display on the at least one display screen to a second orientation having the bottom end of the second display being located at a top end of the at least one display screen, wherein orientation of the first display remains unchanged when the orientation of the second display is switched from the first orientation to the second orientation.

### BRIEF DESCRIPTION OF THE DRAWINGS

The foregoing aspects and other features of the invention are explained in the following description, taken in connection with the accompanying drawings, wherein:

FIG. 1 is a block diagram illustrating one embodiment of the invention;

FIG. 2 is a block diagram illustrating one embodiment of the user interface shown in FIG. 1;

FIG. 3 is a block diagram illustrating another embodiment of the user interface shown in FIG. 1;

FIG. 4 is a top plan view of an example of the apparatus shown in FIGS. 1-2 in a first mode of operation;

FIG. 5 is a top plan view as in FIG. 4 in a second mode of operation;

FIG. 6 is a top plan view as in FIG. 5 showing a different image of one of the thumbnail images shown in the bottom display as the second flipped display on the top screen;

FIG. 7 is a top plan view as in FIG. 5 showing the top display as an enlarged or zoomed portion of the second display shown in FIG. 5;

FIGS. 8-10 are top plan views of the apparatus handset shown in FIGS. 4-7, but showing a gaming application being viewed/shared by two people;

FIGS. 11-13 are top plan views of the apparatus handset shown in FIGS. 4-7, but showing a work application being viewed/shared by two people;

FIG. 14 is a perspective view of an apparatus comprising features of the invention having a single display screen being viewed/shared by two people;

FIG. 15 is an enlarged top plan view of the display screen shown in FIG. 14;

FIG. 16A-16C are top plan views of the display screen shown in FIGS. 14-15 illustrating different pre-defined view settings;

FIG. 17 is a top plan view of the display screen shown in FIGS. 14-15 illustrating a free adjustment percentage of first and second areas on the display screen;

FIG. 18 is a perspective view of an apparatus comprising features of the invention having a single display screen being viewed/shared by two people in a gaming application;

FIG. 19 is an enlarged top plan view of the display screen shown in FIG. 18;

FIG. 20 is a block diagram illustration some steps of one method of the invention;

FIG. 21 is block diagram illustration some steps of another method of the invention;

FIG. 22 is a top plan view of an example of the apparatus shown in FIG. 14 in a first mode of operation;

FIG. 23 is a top view of the apparatus shown in FIG. 22 in a second mode of operation;

FIG. 24 is a top view of the apparatus shown in FIG. 23 with the other person having changed the display;

FIG. 25 is a top view of the apparatus shown in FIG. 24 in a third mode of operation;

FIG. 26 is a top view of the apparatus shown in FIG. 24 back in the first mode of operation;

FIGS. 27-28 are top views of an alternate embodiment of the apparatus shown in FIG. 24 in second and first modes of operation respectively;

FIGS. 29-31 are top views of the embodiment of the apparatus shown in FIG. 24 running game software in first, second and back to first modes of operation respectively.

### DETAILED DESCRIPTION OF EMBODIMENTS

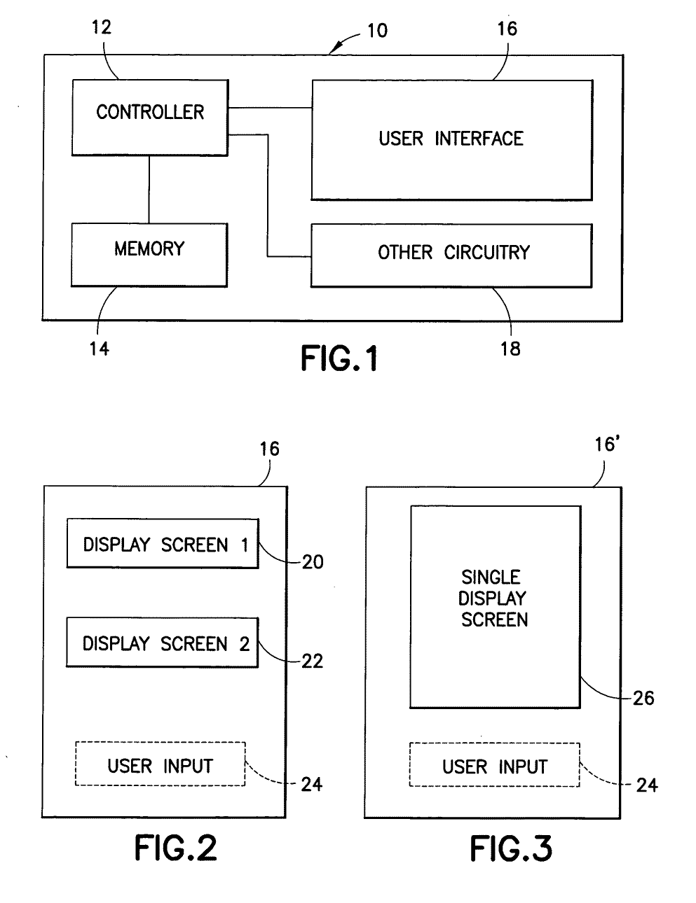

Referring to FIG. 1, there is shown a block diagram of an apparatus 10 incorporating features of the invention. Although the invention will be described with reference to the exemplary embodiments shown in the drawings, it should be understood that the invention can be embodied in many alternate forms of embodiments. In addition, any suitable size, shape or type of elements or materials could be used.

The apparatus 10 generally comprises a controller 12, a memory 14, a user interface 16 and other circuitry 18. In one example embodiment the apparatus is a hand-held mobile telephone. However, in alternate embodiments the apparatus 10 could be any suitable type of portable electronic device, such as a stand alone digital camera for example. As is know in the art, besides wireless communications, hand-held mobile telephones can include additional applications, such as a digital camera, Internet browsing, a calendar, reminders, storage of notes and addresses and other text information, GPS mapping, and gaming for example.

The controller 12 could comprise a microprocessor for example. The memory 14 is connected to the controller 12. The user interface 16 comprises at least one display screen. Examples of the user interface 16 are shown in FIGS. 2-3.

In FIG. 2 the user interface 16 comprises a first display screen 20 and a second display screen 22. The user interface 16 can include at least one user input 24, such as a keypad or joystick or control keys for example. In some circumstances, such as if one or both of the display screens 20, 22 are touch sensitive display screens, the user input 24 need not be provided.

In FIG. 3 the user interface 16′ comprises a single display screen 26. The user interface 16′ can include the at least one user input 24, such as a keypad or joystick or control keys for example. In some circumstances, such as if the single display screen 26 is a touch sensitive display screen, the user input 24 need not be provided.

In the hand-held mobile telephone embodiment, the other circuitry 18 can include, for example, a transceiver and an antenna. The other circuitry 18 can also include a digital camera for example. The controller 12, memory 14 and display screen(s) could be configured with suitable hardware and software to present displays on the display screen(s), such as photograph images, video images, text and games for example.

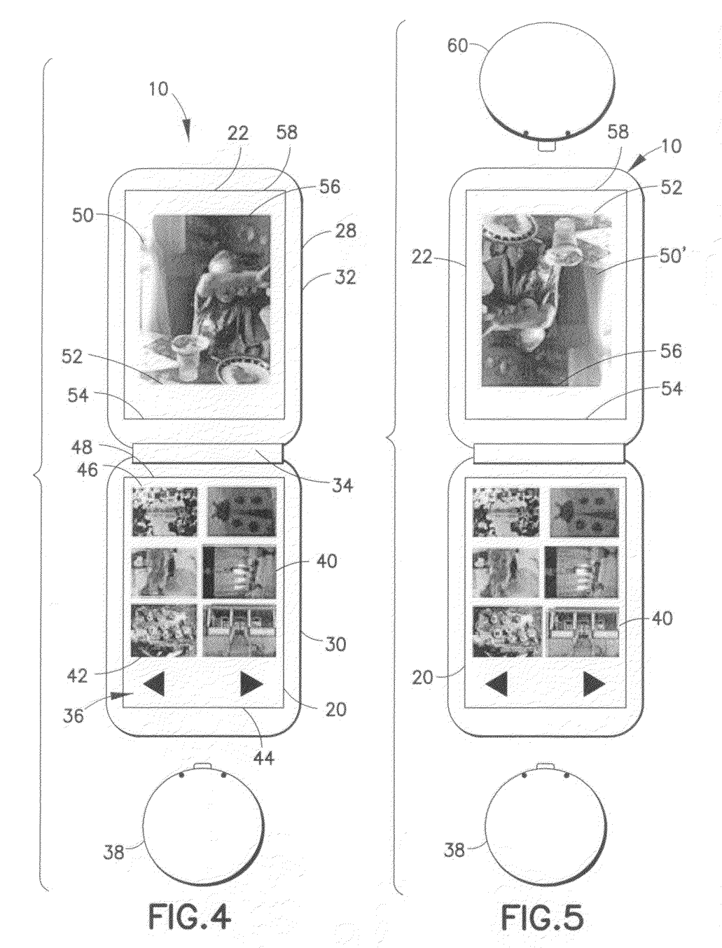

Referring also to FIG. 4, an example embodiment of the apparatus 10 as a mobile telephone handset is shown. In this embodiment the telephone 10 comprises a housing 28. The controller 12, memory 14 and other circuitry 18 are in the housing. The handset is a general clamshell design. Thus, the housing 28 comprises a first housing section 30 pivotably connected with a second housing section 32 by a hinge 34. However, in alternate embodiments any suitable movable connection or joint between the two housing sections could be provided.

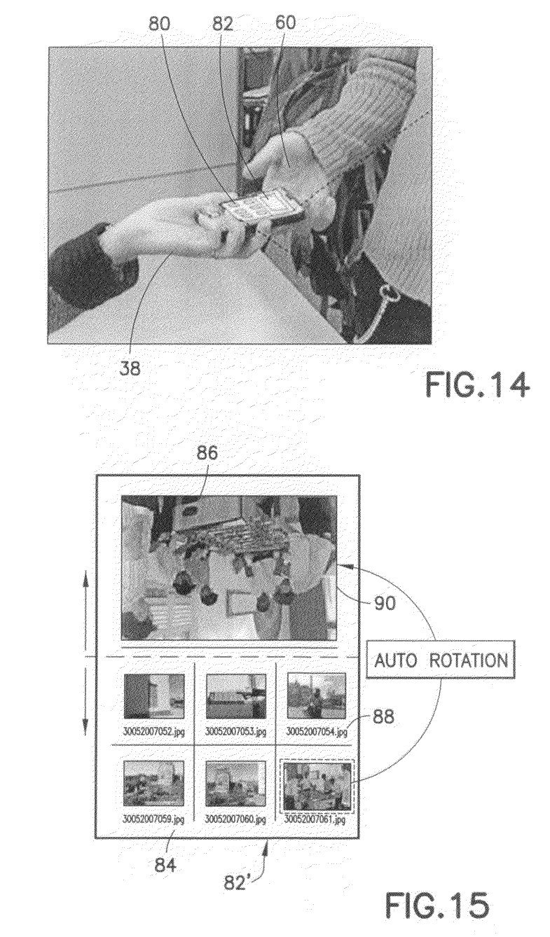

In addition, the housing could comprise more than two housing sections or only a mono or block type of housing as shown in FIG. 14 for example.

FIG. 4 shows the housing 12 in an open configuration. The first display screen 20 is located on a first side of the first housing member 30. The second display screen 22 is located on a first side of the second housing member 32. In the open configuration shown, the two display screens are at a same top side of the handset. However, with the clamshell design, the second housing 32 can be rotated at the hinge 34 to close the second housing section 32 over the first housing section 30. Thus, the first and second display screens can face each other in the closed configuration to thereby protect the screens 20, 22 when the handset is closed.

In this embodiment the screens 20, 22 are both touch screens. However, in alternate embodiments one or both of the screens might not be touch screens. The first screen 20 has a control display 36 shown on the screen 20 for controlling an application. The example control display 36 has left and right arrows for controlling scrolling through pictures in a picture viewer application. However, any suitable control display could be shown. In addition, if the screen is not touch sensitive, it might not show a control display.

One aspect of the invention will be described with reference to FIGS. 4-6 with use of a picture viewer application. However, features of the invention could be used with any suitable application which can be understood from the description further below. As seen in FIG. 4, a user or owner 38 would normally hold the handset 10 for viewing the displays 20, 22 with the first display 20 closer to the user and the second display further away from the user.

In FIG. 4, in addition to presenting the control display 36 on the bottom of the first display screen 20, the digital picture viewer application presents a first display 40 on the first display screen 20. In this example, the first display 40 comprises thumbnails of some of the digital photograph images stored in the memory 14. The first display 40 is orientated such that the images face towards the user 38. A bottom side 42 of the first display 40 is located proximate the bottom end 44 of the first display screen 20. A top side 46 of the first display 40 is located proximate the top end 48 of the first display screen 20; proximate the hinge 34.

In the first mode of operation shown in FIG. 4, the digital picture viewer application presents a second display 50 on the second display screen 22. In this example, the second display 50 comprises a single one of the digital photograph images shown in the thumbnail display 40. The image shown as the second display 50 can be changed by the user merely selecting one of the thumbnail images in the first display 40. The second display 50 is orientated such that the single image faces towards the user 38. A bottom side 52 of the second display 50 is located proximate the bottom end 54 of the second display screen 22; proximate the hinge 34. A top side 56 of the second display 50 is located proximate the top end 58 of the second display screen 22.

Referring also FIG. 5, the handset 10 is shown operating in a second mode of operation. The digital picture viewer application is still being used. The first display 40 on the first display screen 20 is the same as the first mode of operation shown in FIG. 4. Although the image being displayed as the second display screen 22 is the same image displayed in the first mode of operation shown in FIG. 4, the image is flipped 180 degrees. Thus, the image is upside-down relative to the viewing orientation of the user 38. Thus, the second display 50′ is orientated such that the single image faces away from the user 38. The bottom side 52 of the second display 50′ is located proximate the top end 58 of the second display screen 22. A top side 56 of the second display 50′ is located proximate the bottom end 54 of the second display screen 22; proximate the hinge 34. The user 38 can actuate a portion of the user input (or a touch on the touch screen) to switch from the first mode to the second mode, or any suitable automated system for actuating the change could be used.

With the handset operating in the second mode of operation, the user 38 can allow a second person 60 (such as a friend) to view the second display 50′ with the second person located opposite and facing the user 38. The invention can provide an apparatus (such as a mobile telephone handset for example) which can present two displays at a same time, and one of the displays can be rotated relative to the other display in order to support shared usage of the apparatus; the usage being viewing in the example described above.

As noted above, currently mobile phones do not support shared usage of the display(s) on a phone handset at a same time. Conventional devices are so small that it is quite difficult to view the small display screen when people are sitting next to each other. The type of sharing experience which can be provided with the invention can support shared usage. Thus, the invention can provide a lot of new usage scenarios and application development possibilities.

In one example of the invention, a second display on a second display screen of a two display phone could be rotated 180 degrees so that another person sitting/standing opposite to the person holding the phone can view the second display. The second display screen is not rotated; merely the second display/image is rotated in the second display screen. The first display on a first display screen could be orientated for viewing to the first person holding the phone allow the first person to control the second display. This scenario supports, for example, showing images to your friend while you still hold the phone. Your first display could contain thumbnails of images, from which you could choose images that are shown in the second display. When images are opened as the second display, they can be rotated 180 degrees so that your friend (located opposite you) sees them properly.

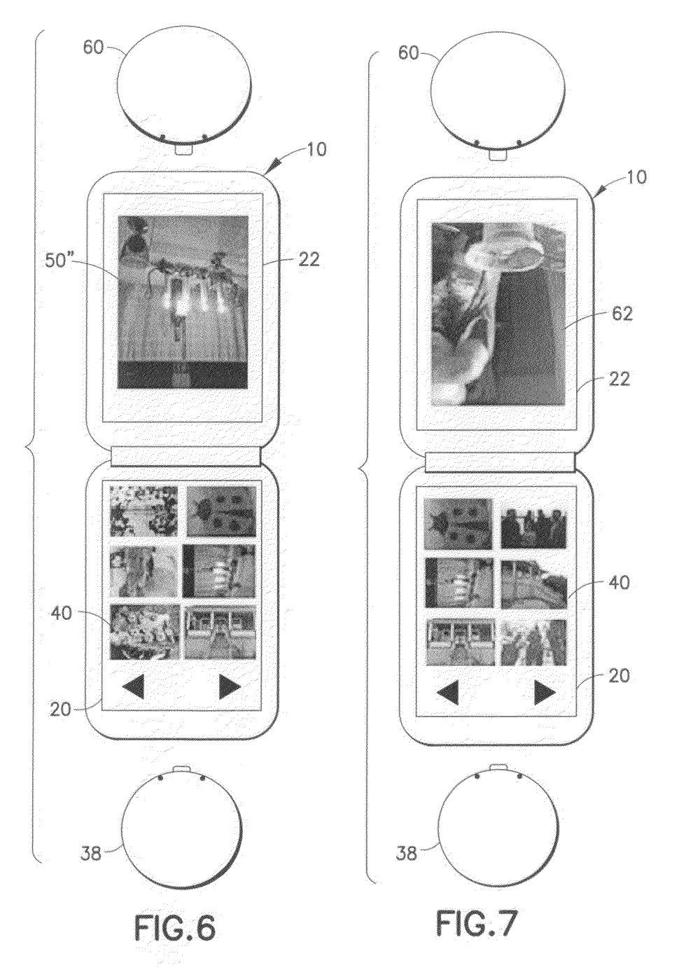

In this example scenario, as seen in FIG. 6, when the user 38 selects another different thumbnail on the display screen 20, the image corresponding to that thumbnail can be automatically presented on the second display screen 22 as the flipped second display 50″. The user 38 could have complete control over the image/display shown on the second display screen 22; the second display screen 22 not allowing user input.

Another scenario is that both of the display screens in the phone could be touch enabled. This way, when the second display is rotated 180 degrees, both the user 38 and the second person 60 could control, at least partially, viewing of the images on one or both of the display screens of the phone. An example of this is shown in FIG. 7. In this example the second person 60 has pressed on a portion of the second display 50′ shown in FIG. 5 to form second display 62 on the second display screen. The second display 62 is an enlarged or zoomed portion of the second display 50′. Besides zoom, any suitable application feature could be made available at the second display screen for use by the second person 60. The application feature could be automatically available and/or selectively available based upon initiation by the user 38.

In the thumbnail/image example scenario mentioned above, in order to avoid the case that the second person 60 recognizes images from the small thumbnails upside down towards him/her, the thumbnails could be so small that the second person could not properly recognize them, but still allow the first person 38 (the user/owner) to recognize the images since they are familiar to him/her.

When both of the display screens have touch support, the apparatus could support even more sharing cases. When viewing images, it is nice that the other person can perform basic viewing tasks (e.g. zoom the image or do something with it); preferably as long as any changes are not saved to the original image unless authorized by the user/owner of the apparatus.

This type of scenario supports different sharing experiences, work-together usages as well as different types of games. For example, if a user wants to show images to a friend, the second display could be rotated as in the earlier example noted with reference to FIGS. 4-6. However, since the second display screen is also touch enabled, the second person can, for example, zoom the image (enlarge the second display) that the first person has opened to him/her.

There are many potential advantages in this invention. Sharing media files, such as images, with another person is more convenient because you do not have to sit very close to each other trying to see from the same small display. The user does not need to give the other person the phone in order for him/her to properly view images and, thus, the user has control over the viewing; only images that user selects are shown in the second display.

Gaming is possible when both of the displays have touch support. An advantage is that the apparatus can enable having games for two users always with the apparatus (such as a hand-held mobile telephone handset for example); so the owner can play with your friend virtually anywhere and anytime. Since both people have their own displays to look at and to play the game with, there is quite a lot of possibilities to create new games, i.e. the display size supports different games. This can merely depend on the imagination of the game developers.

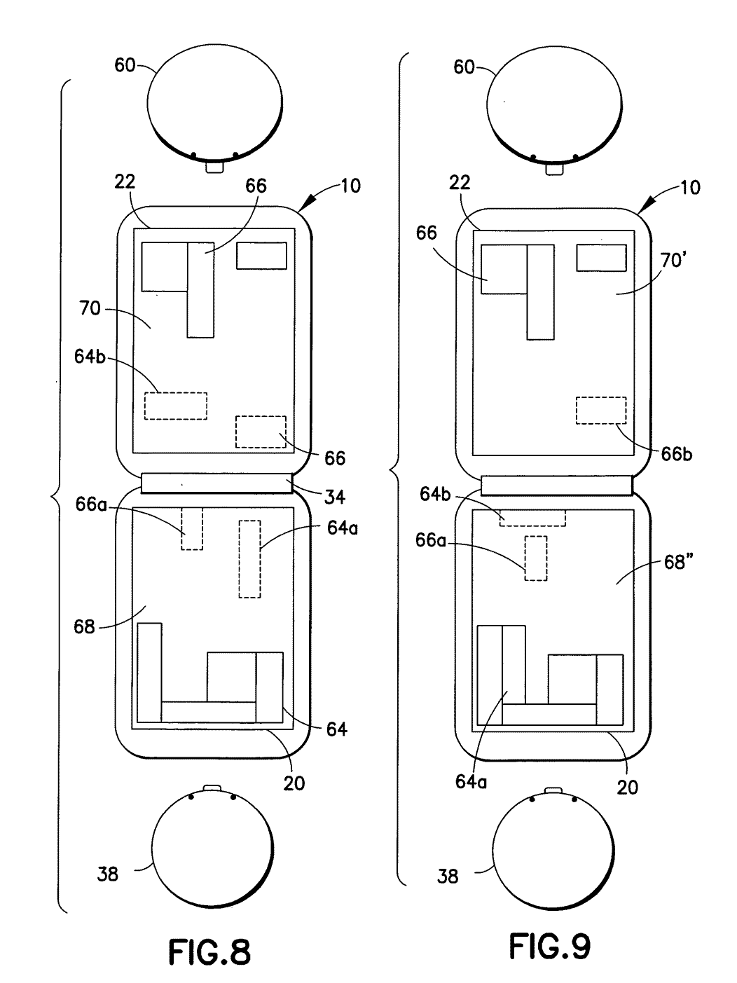

In one example of the invention, a two touch display screen device (with the second display rotated or flipped relative to the first display) can be used for designing games for two users. For example there could be a sort of TETRIS video game, which is similar to a one-player TETRIS game, but enhanced for two-players. An example of this is shown in FIGS. 8-10. Both players 38, 60 could have their own colored blocks that they have to get organized (such as the first player 38 having blue blocks 64 and the second player 60 having green blocks 66). The game could have both colored blocks 64, 66 appear from the upper part of their respective display screens 20, 22 (proximate hinge 34) and which appear to fall down towards the respective opposite player. The player's job could be to send the blocks which belong to the other player towards the other display, and put his/her own colored blocks in place at the bottom of his/her own display.

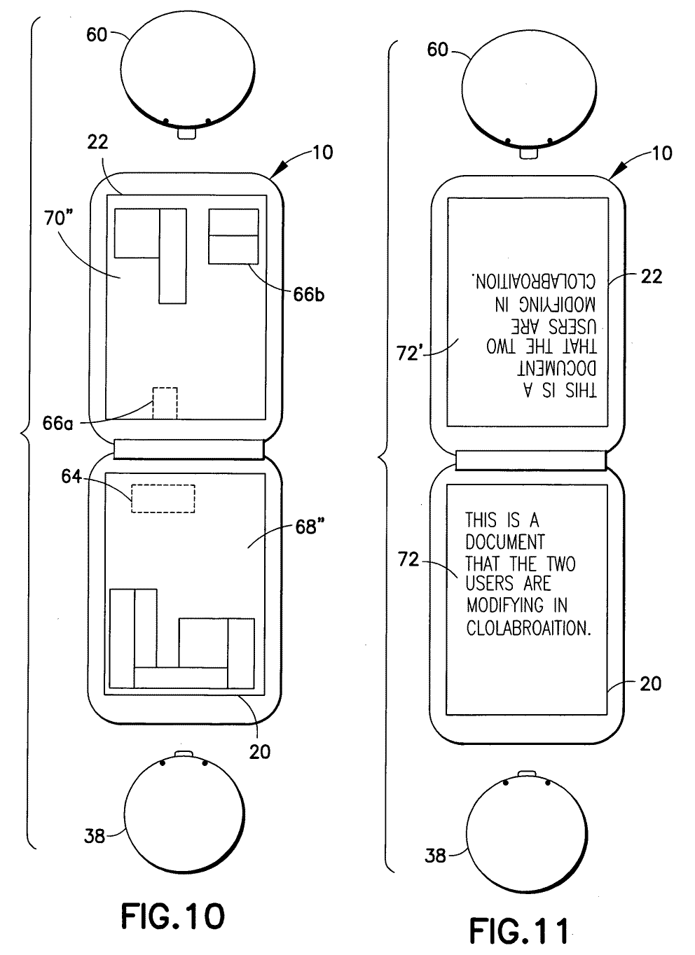

For example, when presented with the displays 68, 70 shown in FIG. 8, the first player 38 can move the blue block 64a to the position shown in FIG. 9, and the second player 60 can swipe the blue piece 64b towards the display screen 20 to move it onto the display 68′ as shown in FIG. 9. When presented with the displays 68′, 70′ shown in FIG. 9, the first player 38 can swipe the green piece 66a towards the second display screen 22 as shown in FIG. 10, and the second player can move the green piece 66b to the correct position shown in FIG. 10. This is obviously merely an example of dual control which could be used with the invention. More advanced features and gaming experiences could use two display screens, from which both display screens support touch. Also with this one, the image of the upper display could to be rotated 180 degrees.

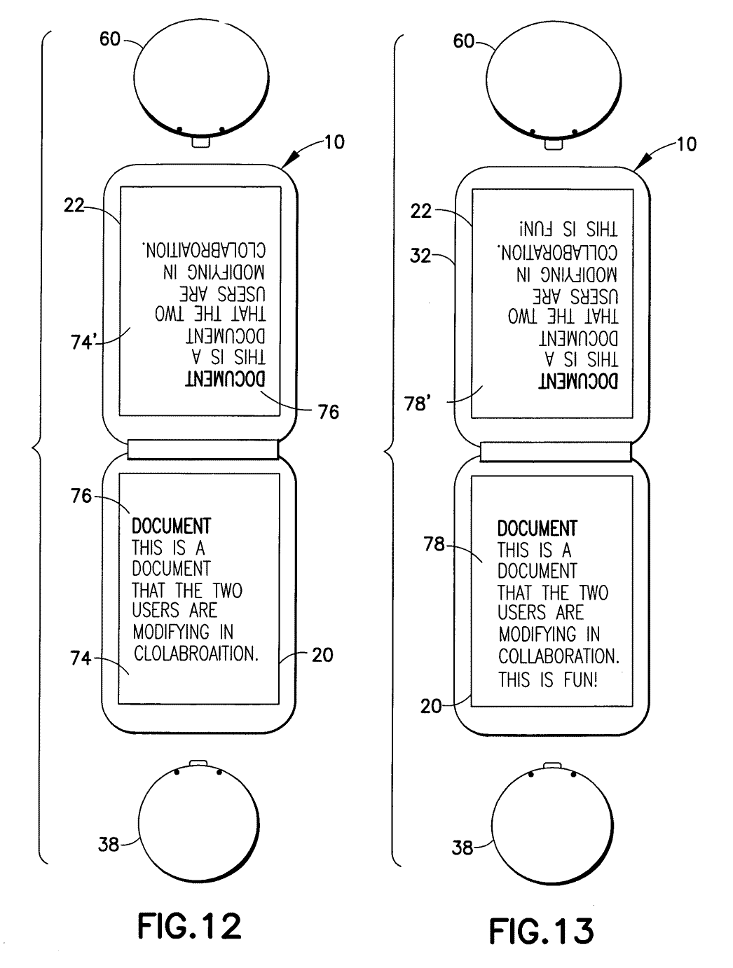

If the mobile phone is used for work tasks, users could also do some work related things in collaboration using only the one apparatus. For example, two people could modify a document on a single handset having two touch screens. An example of this is shown in FIGS. 11-13. As seen comparing FIG. 11 to FIG. 12, the first person 38 could do something on the first touch screen 20 with the second person 60 watching from the second display screen 22. In this example the first person 38 adds a heading 76 to the document. Thus, the first display 72 and flipped second display 72′ are modified into the displays 74 and 74′ with the new heading 76. As seen comparing FIG. 12 to FIG. 13, the second person 60 could then take the lead and modify the document further from the second touch screen 22 or the second housing section 32 while the first person 38 watches the reversely orientated display at first touch screen 20. In the example shown, the second person 60 corrects a typographical error in the text of the document. Thus, the first display 74 and flipped second display 74′ are modified into the displays 78 and 78′ with the typographical error corrected.

The invention is not limited to an apparatus having two display screens. The invention can comprise an apparatus, such as a mobile phone for example, having a single display screen. The invention could also be used on an apparatus having more than one display, but the invention only being used on one of the displays. For example, the invention could comprise dividing a single display screen into two separate areas to present respective displays in each area of the single display screen. This can be used to support sharing and shared experiences on a single display screen. This might be used, for example, to share some specific images with another person or to play some games that utilize the divided or split view.

For the divided/split screen embodiment, one example could comprise the bottom one of the display being presented normally; facing the phone's owner. The upper display could be orientated on the display screen to face the opposite direction. This supports sharing because each user (located on opposite ends of the single display screen) sees their respective displays orientated normally towards them, even thought the two people are located opposite and facing each another.

This kind of splitting and controls could be utilized, for example, in sharing images. An example of this is shown in FIGS. 14-15. As seen in FIG. 14, the first person 38 can hold his/her phone 80 between the first person 38 and the second person 60 with the display screen 82 facing generally upward. In this embodiment the display screen 82 is not a touch screen. As seen in FIG. 15, the single display screen 82 of the phone 80 could be divided/split into two areas; the bottom area 84 and the top area 86. The bottom area 84 could be located at the bottom of the handset 80 closest to the user 38. The top area 86 could be located at the top of the handset 80 closest to the second person 60.

The invention could operate identically to the invention as described above with reference to the two screen example embodiment, but with the area 84 functioning as the first display screen 20 and the area 86 functioning as the second display screen 22. For the picture viewer application, the first area could contain a plurality of the user's images presented as small thumbnails for example. The mobile phone owner could go through his/her images as thumbnails and select images to be displayed on the second area of the display screen so that the other person can look at the image(s). This way the user does not need to give the phone to the other person. The user also does not need to show all the images, but has control what the other person sees. Thus, in the picture viewer application example, thumbnails could be presented at the area 84 as the first display 88 and one of the images of the thumbnails could be presented at the area 86 as the second display 90 having a flipped viewing orientation relative to the viewing orientation of the first display 88.

This use case could work both in non-touch screen and touch screen devices since the upper part 86 does not need any input possibilities; it is only for viewing images. But a touch screen does add something to the experience since the second person 60 that is viewing the images could, for example, zoom the image.

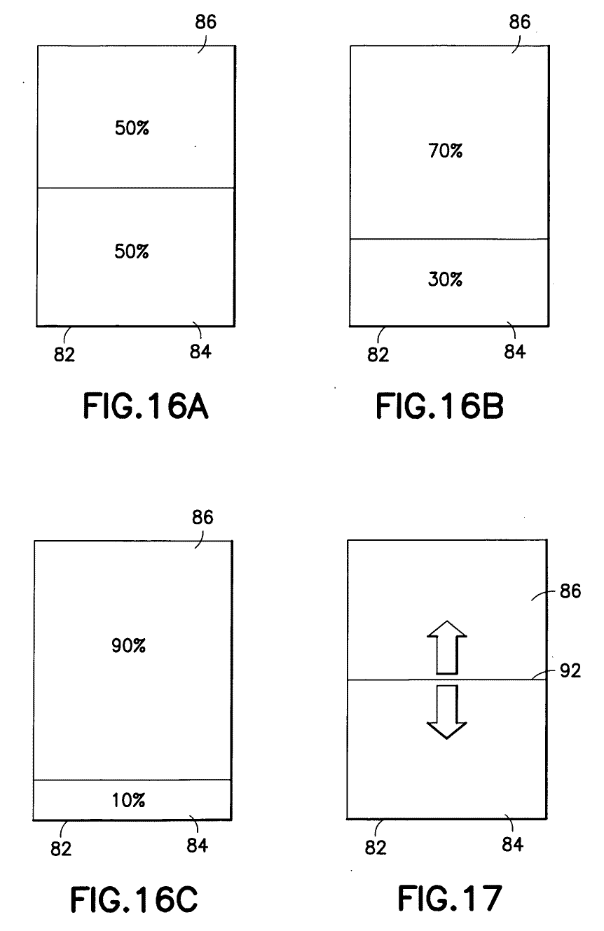

The first person could start an image sharing session, where a single display screen could be divided in two areas: a first area facing the mobile phone owner and a second area facing the other person could fill the rest of the display. The dividing proportions would depend on the usage—it might be 50/50 percent, 70/30 percent, 30/70 percent or what ever fits the use case. Referring also to FIGS. 16A, 16B and 16C, the invention can comprise one or more pre-defined view settings for the display screen 82. FIG. 16A shows a first pre-defined view setting of 50 percent for the first area 84 and 50 percent for the second area 86. FIG. 16B shows a second pre-defined view setting of 30 percent for the first area 84 and 70 percent for the second area 86. FIG. 16C shows a third pre-defined view setting of 10 percent for the first area 84 and 90 percent for the second area 86. More or less pre-defined view settings could be provided. In addition, any suitable percentages could be provided, and more than two areas could be provided.

The selection of the pre-defined view setting could be automatic, such as with a default setting and/or application situation settings, and/or manually user selectable. Referring also to FIG. 17, selection of the view setting could be non-predefined. The split line 92 could be selectively moved by the user 38 and/or user 60, and/or the application based upon predetermined factors (such as a vertical size of a digital picture for example).

For a gaming experience, this feature could be beneficial for touch devices since both views could use the touch screen input mechanism to allow gaming. For example, the first area could be a smaller area, for example 30 percent of the display screen, and the second area could be a bigger area, for example 70 percent of the display screen.

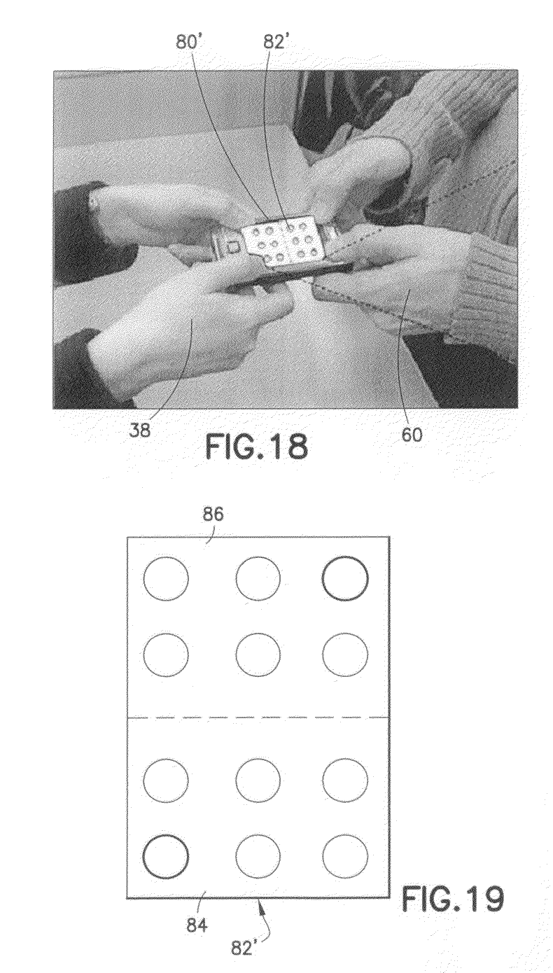

In touch devices, some kinds of games could be provided where the display is divided into two area (such as 50/50 percent) and both areas could have input and user input component control mechanisms based on touch. This type of divided view and user input component control could support developing a lot of different games where interaction is the key element. An example of a game is shown in FIGS. 18 and 19. In this example the display screen 82′ of the apparatus 80′ is a touch screen which has the first area 84 and the second area 86. Both areas 84, 86 can be used for viewing their respective displays at the same time, and for inputting by the users 38, 60 perhaps at the same time or sequentially.

The respective displays on the two areas 84, 86 could have different input mechanisms, such as different gestures icons or buttons. They do not need to be exactly the same. As an example game, there might be some kind of speed game where users compete with each other. Both send something from their own display to the other display, and they have to react as quickly as possible to the other person's “material” or what ever is sent between the users.

There is clear advantage of dividing and flipping the view in cases such as sharing images, like explained above. Us of dividing and flipping of views/displays fits also for other media sharing, like sharing video clips. There are also many possibilities for developing shared games, as mentioned.

of course, when the apparatus is a mobile telephone handset, an advantage is that you almost always have your phone with you, and you can start a game with your friend whenever and wherever; and the shared experience makes it more fun than games meant for only one person.

In accordance with one aspect of the invention, an apparatus 10 is provided including a housing 28; at least one display screen 20, 22 or 82 on a first side of the housing; and a controller 12. The controller is configured to display a first display (such as 40 for example) on the at least one display screen and a second display (such as 50 for example) on the at least one display screen at a same time such that the first display has a bottom side 42 proximate a bottom end 44 of the at least one display screen and the second display has a bottom side 52 proximate a top end 58 of the at least one display screen. The first display and the second display are generally flipped relative to each other.

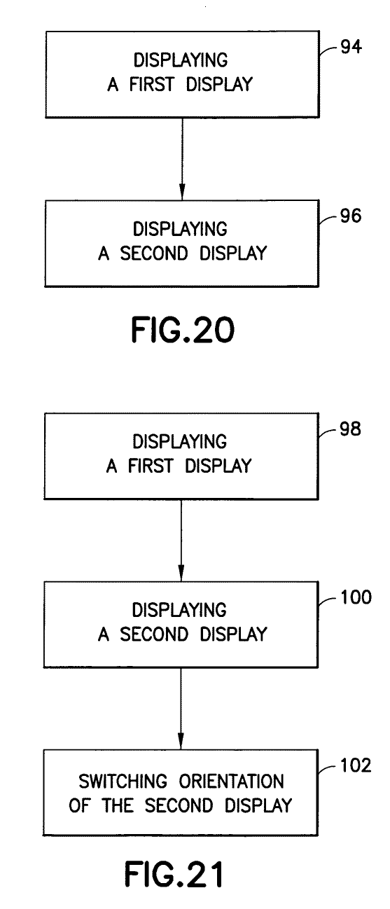

Referring also to FIG. 20, in accordance with another aspect of the invention, a method is provided comprising displaying a first display on at least one display screen of an apparatus as indicated by block 94, wherein the first display has a bottom side proximate a bottom end of the at least one display screen; and displaying as indicated by block 96 a second display on the at least one display screen at a same time that the first display is displayed on the at least one display screen, wherein the second display has a bottom side proximate a top end of the at least one display screen, wherein the second display is flipped about 180 degrees relative to the first display.

In accordance with another aspect of the invention, a program storage device (14 for example) is provided which is readable by an apparatus, tangibly embodying a program of instructions executable by the apparatus for performing operations to present displays on at least one display screen of the apparatus, the operations comprising displaying a first one of the displays on the at least one display screen, wherein the first display has a bottom side proximate a bottom end of the at least one display screen; and displaying a second one of the displays on the at least one display screen at a same time that the first display is displayed on the at least one display screen, wherein the second display has a bottom side proximate a top end of the at least one display screen, wherein the second display is flipped about 180 degrees relative to the first display.

In accordance with another aspect of the invention, an apparatus (10 or 80 for example) is provided comprising a housing 28; at least one display screen (20, 22 or 82) on a first side of the housing; and a controller 12. The controller is configured to display a first display (40 for example) on the at least one display screen and a second display (50 for example) on the at least one display screen at a same time. The controller is configured to operate in a first mode of operation to display the first display with a bottom side proximate a bottom end of the at least one display screen and the second display with a bottom side proximate a middle of the housing. The controller is configured to operate in a second mode of operation to display the first display with its bottom side proximate the bottom end of the at least one display screen and the second display with its bottom side proximate a top end of the at least one display screen such that the first display and the second display are generally flipped relative to each other in the second mode of operation.

In accordance with another aspect of the invention, a method is provided comprising displaying a first display on at least one display screen of an apparatus as indicated by block 98, wherein the first display has a bottom side proximate a bottom end of the at least one display screen; displaying as indicated by block 100 a second display on the at least one display screen of the apparatus at a same time that the first display is displayed on the at least one display screen, wherein the second display is displayed in a first orientation having a bottom side opposite a top side of first display; and switching orientation of the second display on the at least one display screen as indicated by block 102 to a second orientation having the bottom side of the second display being located at a top end of the at least one display screen, wherein orientation of the first display remains unchanged when the orientation of the second display is switched from the first orientation to the second orientation.

In accordance with another aspect of the invention, a program storage device (14 for example) is provided which is readable by an apparatus, tangibly embodying a program of instructions executable by the apparatus for performing operations to present displays on at least one display screen of the apparatus, the operations comprising displaying a first one of the displays on at least one display screen, wherein the first display has a bottom side proximate a bottom end of the at least one display screen; displaying a second one of the displays on the at least one display screen at a same time that the first display is displayed on the at least one display screen, wherein the second display is displayed in a first orientation having a bottom side opposite a top side of first display; and switching orientation of the second display on the at least one display screen to a second orientation having the bottom end of the second display being located at a top end of the at least one display screen, wherein orientation of the first display remains unchanged when the orientation of the second display is switched from the first orientation to the second orientation.

Features of the invention could be used such as when the apparatus 10, 80 is connected to a larger viewing screen, such as a table top viewer having one or more display screens. The connection could be a wireless connection for example, such as when the apparatus is merely placed on top of the table top viewer for example.

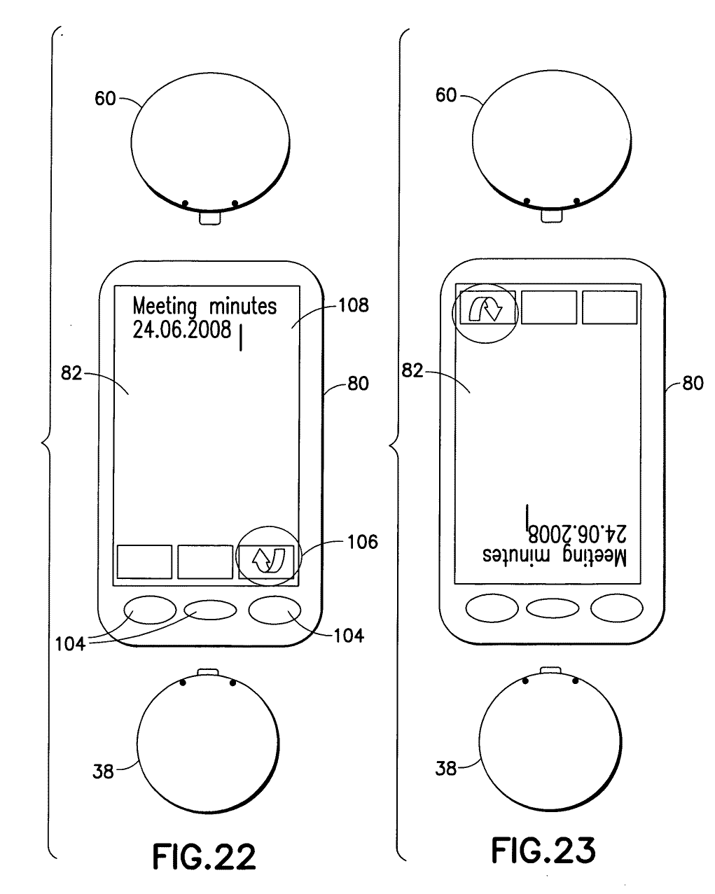

Referring also to FIGS. 22-26 another example of the invention will be described. In this embodiment the apparatus 80 has a single display screen 82 and user control buttons 104 on its main user interface side. However, features of this example of the invention could be used with an apparatus having multiple screens, such as the apparatus 10 shown in FIG. 4, and with more or less control buttons on its main user interface side (such as no control buttons on its main user interface side for example).

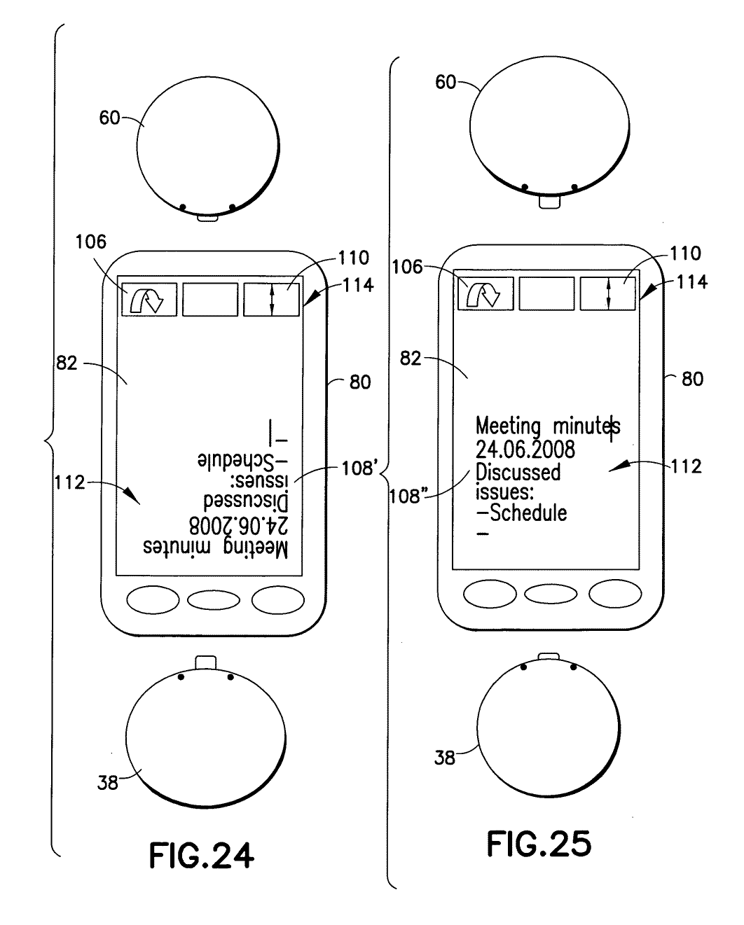

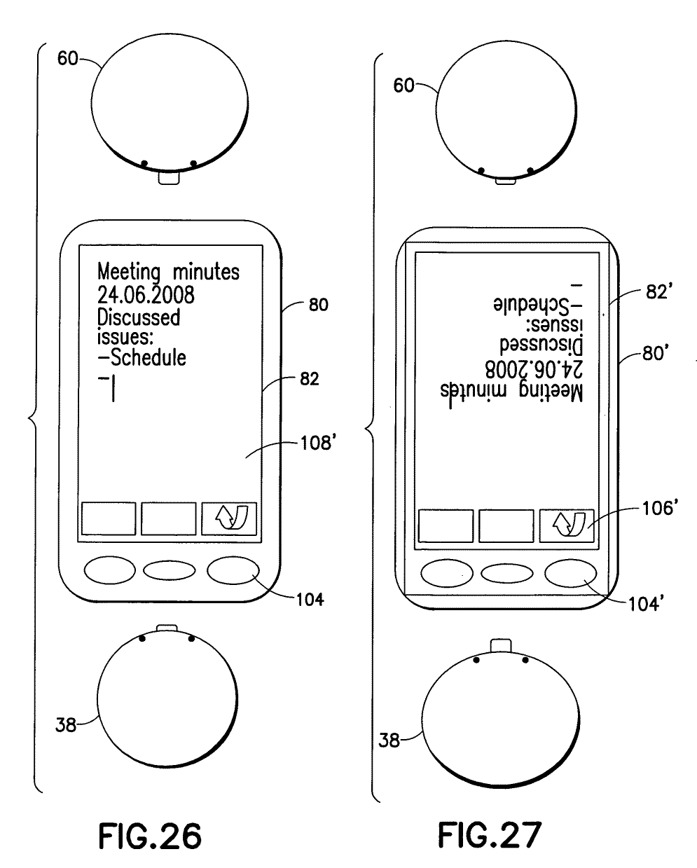

When using one phone/apparatus 80 to do things, such as a phone having a touch screen 82, there could be some kind of button/icon 106 and software, etc. with which the user 38 could allow the other person 60 to continue something, such as editing some document display 108 or playing a game for example on the display screen 82. As seen by comparing FIG. 22 to FIG. 23, when the user 38 presses the button or icon 106, the view would auto-rotate 180 degrees towards the other person 60. The other person 60 could edit the document as seen in comparing FIG. 23 to FIG. 24 to form document display 108′. The other person 60 could press a button or icon 110 to auto-rotate 180 degrees only a portion 112 of the document display 108′ (such as the portion having the text) with another portion 114 (such as the portion having the input/control icons 106, 110) not auto-rotating. This would form display 108″. Pressing the icon 110 again could return the view to the display 108′ shown in FIG. 24, or the other person 60 could press the icon 106 to result in the display 108′ being auto-rotated 180 degrees to the new view shown in FIG. 26. Additionally or alternatively, the user 38 could press one of the buttons 104 to cause the view shown in FIG. 26. Pressing icon 106 while at the state shown in FIG. 24 would automatically result in the state shown in FIG. 26 without the need for the state shown in FIG. 25. In one type of embodiment the icon 110 and a semi-autorotation feature might not be provided. This type of example illustrates shared tasks on divided view. This type of example illustrates using a button or icon to allow the other person to continue, i.e. after pressing the button, the view turns so that the other person can continue.

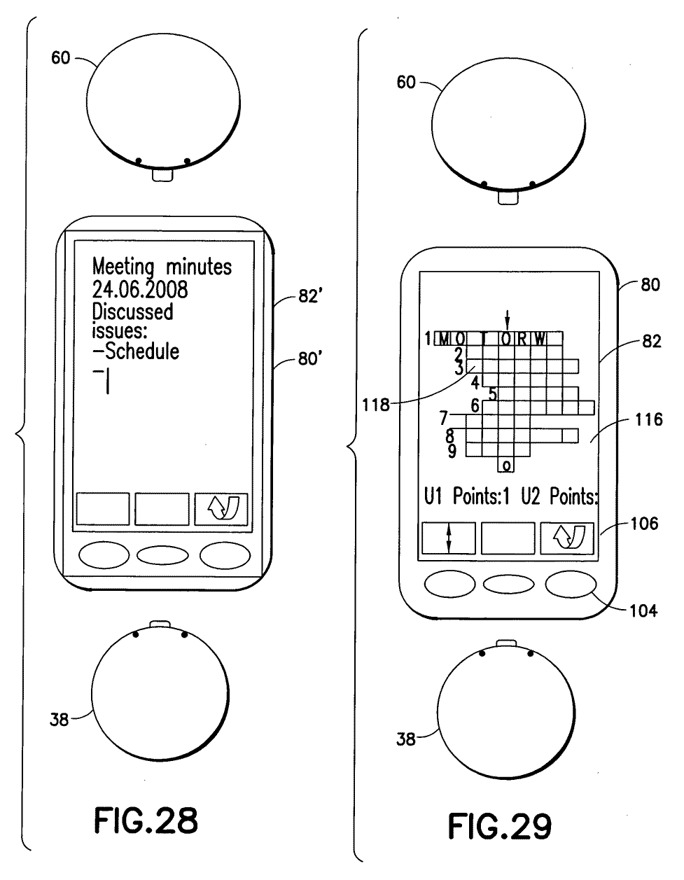

Referring also to FIGS. 27-28, this example illustrates an apparatus 80′ with a touch screen 82′. The touch screen 82′ has control icons 104′ and icons 106′ which might not auto-rotate when the text portion of the display is rotated.

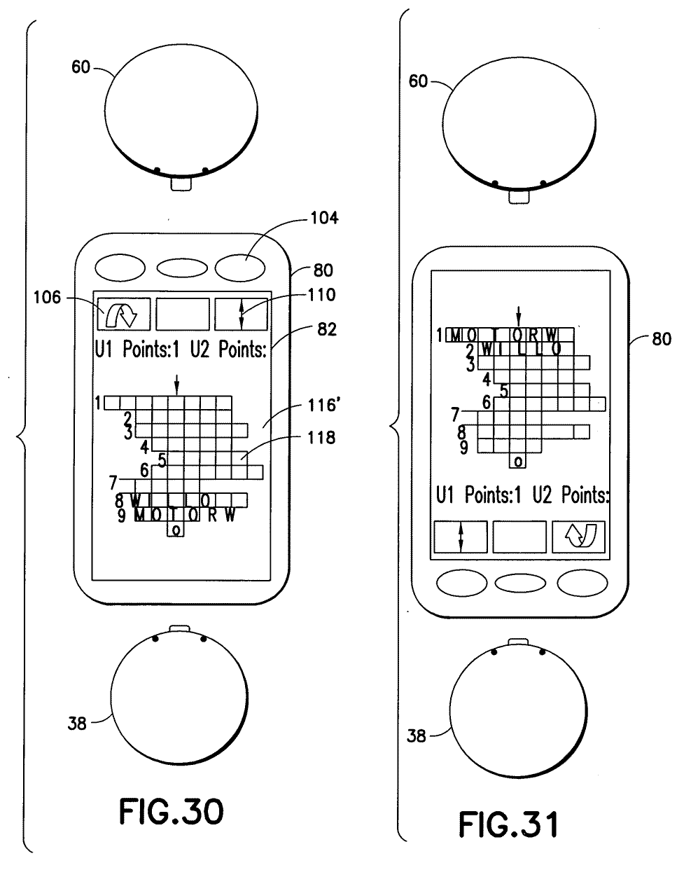

Referring also to FIGS. 29-31 an example of using the apparatus 80 with game software is shown. This shows a shared game on a divided view. In FIG. 29 the handset 80 has a display 116 orientated towards the user 38. The user 38 could press the icon 106 and hand the handset 80 to the other person 60 (rotating the handset) such that the other person 60 can use the buttons 104, but the display 116 is rotated 180 degrees to form display 116′ so the game portion 118 of the display is still orientated towards the user 38, but the control icons, such as 106, at located proximate the other user 60. Icon 110 could be used to flip only the game portion 118. Icon 106 could be used to flip the display back to the position shown in FIG. 31 and the handset returned to the user 38. In an alternate embodiment the handset might not be physically flipped, such as illustrated by the embodiment described with reference to FIGS. 27-28.

With these embodiments the flip controls, such as dedicated icons 106, 110, are designed to rotate the display (or portion of the display) a predetermined amount of only 180 degrees. The icons 106, 110 cannot be used to rotate the display 90 degrees, such as used with viewer programs such as ADOBE ACROBAT viewer for example. However, an additional icon could be provided to rotate the display 90 degrees such as for using the display screen 82, 82′ in a landscape orientation between the two people 38, 60 with the icons 106 and/or 110 being usable for flipping the display or portion of the display 180 degrees while in that landscape orientation.

It should be understood that the foregoing description is only illustrative of the invention. Various alternatives and modifications can be devised by those skilled in the art without departing from the invention. For example, features recited in the various dependent claims could be combined with each other in any suitable combination(s). In addition, features from different embodiments described above could be selectively combined into a new embodiment. Accordingly, the invention is intended to embrace all such alternatives, modifications and variances which fall within the scope of the appended claims.

What is claimed is:

1. An apparatus comprising:
a housing;
at least one display screen on a first side of the housing; and
a controller configured to display a first display on the at least one display screen and a second display on the at least one display screen at a same time,
wherein the first display has a bottom side proximate a bottom end of the at least one display screen, and wherein the second display has a bottom side proximate a top end of the at least one display screen, such that the first display and the second display are generally flipped relative to each other.

2. An apparatus as in claim 1 wherein the housing comprises a first housing section movably mounted to a second housing section.

3. An apparatus as in claim 2 wherein the at least one display screen comprises a first display screen on the first housing section and a second display screen on the second housing section.

4. An apparatus as in claim 3 wherein the second housing section is pivotably connected to the first housing section in a general clamshell configuration.

5. An apparatus as in claim 4 wherein the first and second display screens generally face each other when the housing is in a closed position.

6. An apparatus as in claim 1 wherein the controller is configured to switch orientation of the second display on the at least one display screen such that the second display has a bottom side opposite a top side of the first display without changing orientation of the first display on the at least one display screen.

7. An apparatus as in claim 1 wherein the at least one display screen comprises at least one touch screen to function as a user input into the apparatus.

8. An apparatus as in claim 1 wherein the at least one display screen comprises a first display screen and a separate second display screen, and wherein the first and the second display screen each comprise a touch screen to function as separate user inputs into the apparatus.

9. An apparatus as in claim 1 wherein the at least one display screen comprises a single display screen on the first side of the housing.

10. An apparatus as in claim 9 wherein the controller is configured to present the first and second displays as a split screen format on the single display screen.

11. An apparatus as in claim 10 wherein the controller is adapted to split screen format the first and second displays in at least two pre-defined view settings comprising:
a first pre-defined view setting comprising:
the first display occupying a first percentage of the single display screen, and
the second display occupying a second remaining percentage of the single display screen; and
a second pre-defined view setting comprising:
the first display occupying a third percentage of the single display screen which is different from the first percentage, and
the second display occupying a fourth remaining percentage of the single display screen which is different from the second percentage.

12. An apparatus as in claim 11 wherein the controller is adapted to split screen format the first and second displays in a free adjustment view setting with the first display occupying a first variable percentage of the single display screen, and the second display occupying a second remaining percentage of the single display screen.

13. An apparatus as in claim 9 wherein the controller is adapted to split screen format the first and second displays in a free adjustment view setting with the first display occupying a first variable percentage of the single display screen, and the second display occupying a second remaining percentage of the single display screen.

14. A method comprising:
displaying a first display on at least one display screen of an apparatus, wherein the first display has a bottom side proximate a bottom end of the at least one display screen; and
displaying a second display on the at least one display screen at a same time that the first display is displayed on the at least one display screen, wherein the second display has a bottom side proximate a top end of the at least one display screen, wherein the second display is flipped about 180 degrees relative to the first display.

15. A method as in claim 14 further comprising switching orientation of the second display on the at least one display screen such that a top side of the second display is located at the top end of the at least one display screen, wherein orientation of the first display remains unchanged when the orientation of the second display is switched.

16. A method as in claim 14 wherein the at least one display screen comprises a single display screen with the steps of displaying comprising displaying the first and second displays on the single display screen at the same time.

17. A method as in claim 14 further comprising changing a view setting on the single display screen from:
a first view setting comprising:
the first display occupying a first percentage of the single display screen, and
the second display occupying a second remaining percentage of the single display screen;
to:
a second view setting comprising:
the first display occupying a third percentage of the single display screen which is different from the first percentage, and
the second display occupying a fourth remaining percentage of the single display screen which is different from the second percentage.

18. A method as in claim 17 wherein the first and second view settings are pre-defined view settings with pre-defined percentages.

19. A method as in claim 17 wherein the percentage of the first and second view settings are freely adjustable by a user.

20. A method as in claim 14 wherein displaying the first display comprises displaying thumbnails of images as the first display while displaying an image corresponding to one of the thumbnails as the second display.

21. A method as in claim 14 wherein displaying the first display comprises displaying a first game player screen image of an electronic game as the first display, and displaying the second display comprises displaying a second game player screen image as the second display.

22. A method as in claim 14 wherein displaying the first display comprises displaying text as the first display and displaying the second display comprises displaying the same text as the second display.

23. A method as in claim 14 wherein the at least one display screen comprises at least one touch screen, and the method further comprises receiving an input signal from the at least one touch screen.

24. A method as in claim 14 wherein the at least one display screen comprises a first display screen and a separate second display screen which is movably connected to the first display screen at a joint, wherein a top side of the first display is displayed opposite the joint and a top side of the second display is displayed opposite the joint.

25. A method as in claim 24 wherein the first and the second display screens each comprise a touch screen, and the method further comprises receiving separate input signals from the touch screens.

26. A program storage device readable by an apparatus, tangibly embodying a program of instructions executable by the apparatus for performing operations to present displays on at least one display screen of the apparatus, the operations comprising:
displaying a first one of the displays on the at least one display screen, wherein the first display has a bottom side proximate a bottom end of the at least one display screen; and
displaying a second one of the displays on the at least one display screen at a same time that the first display is displayed on the at least one display screen, wherein the second display has a bottom side proximate a top end of the at least one display screen, wherein the second display is flipped about 180 degrees relative to the first display.

27. A program storage device as in claim 26 wherein the operations further comprise switching orientation of the second display on the at least one display screen such that a top side of the second display is located at the top end of the at least one display screen, wherein orientation of the first display remains unchanged when the orientation of the second display is switched.

28. A program storage device as in claim 26 wherein the at least one display screen comprises a single display screen and the operations further comprise changing a view setting on the single display screen from:
a first view setting comprising:
the first display occupying a first percentage of the single display screen, and
the second display occupying a second remaining percentage of the single display screen;
to:
a second view setting comprising:
the first display occupying a third percentage of the single display screen which is different from the first percentage, and
the second display occupying a fourth remaining percentage of the single display screen which is different from the second percentage.

29. An apparatus comprising:
a housing;
at least one display screen on a first side of the housing; and
a controller configured to display a first display on the at least one display screen and a second display on the at least one display screen at a same time,
wherein the controller is configured to operate in a first mode of operation to display the first display with a bottom side proximate a bottom end of the at least one display screen and the second display with a bottom side proximate a middle of the housing, and
wherein the controller is configured to operate in a second mode of operation to display the first display with its bottom side proximate the bottom end of the at least one display screen and the second display with its bottom side proximate a top end of the at least one display screen such that the first display and the second display are generally flipped relative to each other in the second mode of operation.

30. An apparatus as in claim 29 wherein the at least one display screen comprises a first display screen on a first housing section of the housing and a second display screen on a movable second housing section of the housing.

31. An apparatus as in claim 29 wherein the at least one display screen comprises a single display screen.

32. A method comprising:
displaying a first display on at least one display screen of an apparatus, wherein the first display has a bottom side proximate a bottom end of the at least one display screen;
displaying a second display on the at least one display screen of the apparatus at a same time that the first display is displayed on the at least one display screen, wherein the second display is displayed in a first orientation having a bottom side opposite a top side of first display; and
switching orientation of the second display on the at least one display screen to a second orientation having the bottom side of the second display being located at a top end of the at least one display screen, wherein orientation of the first display remains unchanged when the orientation of the second display is switched from the first orientation to the second orientation.

33. A method as in claim 32 wherein the at least one display screen comprises a single display screen with the steps of displaying comprising displaying the first and second displays on the single display screen at the same time.

34. A program storage device readable by an apparatus, tangibly embodying a program of instructions executable by the apparatus for performing operations to present displays on at least one display screen of the apparatus, the operations comprising:
displaying a first one of the displays on at least one display screen, wherein the first display has a bottom side proximate a bottom end of the at least one display screen;
displaying a second one of the displays on the at least one display screen at a same time that the first display is displayed on the at least one display screen, wherein the second display is displayed in a first orientation having a bottom side opposite a top side of first display; and
switching orientation of the second display on the at least one display screen to a second orientation having the bottom end of the second display being located at a top end of the at least one display screen, wherein orientation of the first display remains unchanged when the orientation of the second display is switched from the first orientation to the second orientation.

35. A program storage device as in claim 34 wherein the at least one display screen comprises a single display screen and the operations further comprise changing a view setting on the single display screen from:
a first view setting comprising:
the first display occupying a first percentage of the single display screen, and
the second display occupying a second remaining percentage of the single display screen;
to:
a second view setting comprising:
the first display occupying a third percentage of the single display screen which is different from the first percentage, and
the second display occupying a fourth remaining percentage of the single display screen which is different from the second percentage.
